(19) United States
(12) Patent Application Publication
(10) Pub. No.: US 2023/0351539 A1
(43) Pub. Date: Nov. 2, 2023

(54) V2X SMART TOLLING LEAKAGE PREVENTION

(71) Applicant: FORD GLOBAL TECHNOLOGIES, LLC, Dearborn, MI (US)

(72) Inventors: Krishna BANDI, Farmington Hills, MI (US); Samer IBRAHIM, Dearborn, MI (US); Sathyanarayana Chary PALAKONDA, Northville, MI (US); Swetha SHAILENDRA, Royal Oak, MI (US); Syed Amaar AHMAD, Canton, MI (US)

(21) Appl. No.: 17/732,619

(22) Filed: Apr. 29, 2022

(51) Int. Cl. G06Q 50/30; G06Q 20/04

(52) U.S. Cl. CPC G06Q 50/30; G06Q 20/047; H04W 4/40

(57) ABSTRACT

Smart tolling leakage prevention is provided. A TUM is stored to a TUM database, the TUM including information with respect to traversal of a vehicle along a roadway for which charges are incurred for travel. The TUM is sent, via a transceiver of the vehicle, to a road-side unit (RSU) in communication with a tolling system. A toll receipt message (TRM) is received, via the transceiver, from the tolling system. The TUM is reconciled with the TRM. A status of the reconciling is indicated.

### TECHNICAL FIELD

Aspects of the present disclosure generally relate to smart toll application determining for various toll applications using vehicle-to-everything (V2X) communications.

### BACKGROUND

V2X Tolling may refer to electronic fee collection (EFC) toll charging supported by electronic equipment on-board of a vehicle configured for V2X communication. These V2X communications may include the exchange of information between various infrastructure elements.

### SUMMARY

In one or more illustrative examples, a vehicle for smart tolling leakage prevention is provided. The vehicle includes a toll usage message (TUM) database, a transceiver, and a controller. The controller is programmed to store a TUM to the TUM database, the TUM including information with respect to traversal of the vehicle along a roadway for which charges are incurred for travel, send, via the transceiver, the TUM to a road-side unit (RSU) in communication with a tolling system, receive, via the transceiver, a toll receipt message (TRM) from the tolling system, the TRM, reconcile the TUM with the TRM, and indicate a status of the reconcile.

In one or more illustrative examples, a method for smart tolling leakage prevention is provided. A TUM is stored to a TUM database, the TUM including information with respect to traversal of a vehicle along a roadway for which charges are incurred for travel. The TUM is sent, via a transceiver of the vehicle, to a RSU in communication with a tolling system. A TRM is received, via the transceiver, from the tolling system. The TUM is reconciled with the TRM. A status of the reconciling is indicated.

In one or more illustrative examples, a non-transitory computer readable medium comprising instructions for smart tolling leakage prevention, that, when executed by a processor cause the processor to perform operations including to store a TUM to a TUM database, the TUM including information with respect to traversal of a vehicle along a roadway for which charges are incurred for travel, send, via a transceiver of the vehicle, the TUM to a RSU in communication with a tolling system, receive, via the transceiver, a TRM from the tolling system, the TRM, reconcile the TUM with the TRM, and indicate a status of the reconcile.

### BRIEF DESCRIPTION OF THE DRAWINGS

FIG. 1 illustrates an example system for V2X smart tolling leakage prevention;

FIG. 2 illustrates an example of the vehicle approaching a toll gantry;

FIG. 3 illustrates an example of the vehicle approaching a toll usage location;

FIG. 4 illustrates an example of the vehicle receiving a toll receipt message for the completed tolling transaction;

FIG. 5 illustrates an example of the vehicle storing the toll usage message to a toll usage message database of the vehicle;

FIG. 6 illustrates an example process for V2X smart tolling leakage prevention; and

FIG. 7 illustrates an example computing device for V2X smart tolling leakage prevention.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Enforcement of toll charges is an important part of vehicle tolling. Tolling payments that are not collected may be referred to as tolling leakage. Leakage may be the result of various factors. These may include, for example, hidden license plates, dummies to simulate extra passengers for tricking camera occupancy systems, and tool gantry camera issues.

In many systems, a vehicle may approach a tolling enforcement system such as a gantry. Presence of the vehicle may be detected using sensors such as in-pavement loops or laser sensors. A camera on the gantry may take a picture of the vehicle license plate as the vehicle passes.

An improved tolling system may utilize V2X functionality to augment the gantry-based tolling procedure. The system may leverage the vehicle's V2X technology and vehicle's omni-directional viewing and/or sensing capabilities to broadcast or share information with the tolling authority. This may be done to reducing the leakage of tolling using a traditional digital video auditing system (DVAS). In the disclosed approach, the vehicle may be configured to broadcast a message referred to as a TUM. The TUM may contain information useful for reducing the transaction leakage and aiding in toll enforcement, for gantry or for gantry-less tolling.

The vehicle may also maintain recent TUM data to the vehicle. Thus, retained data may be used for further proof of reconciliation, as a further way to reduce leakage during dispute resolution. In many examples the TUM data maintained to the vehicle may include a snapshot from a vehicle camera sensor at the toll gantry to be reconciled. If the vehicle lacks a TUM time/path history matching the charges indicated by the toll charger, then this information may be relevant for a dispute resolution. For privacy, the TUM may utilize fields other than license plate as a key for transactions. For example, intermediate fields such as vehicle identity, toll service provider, or unique tags may be used.

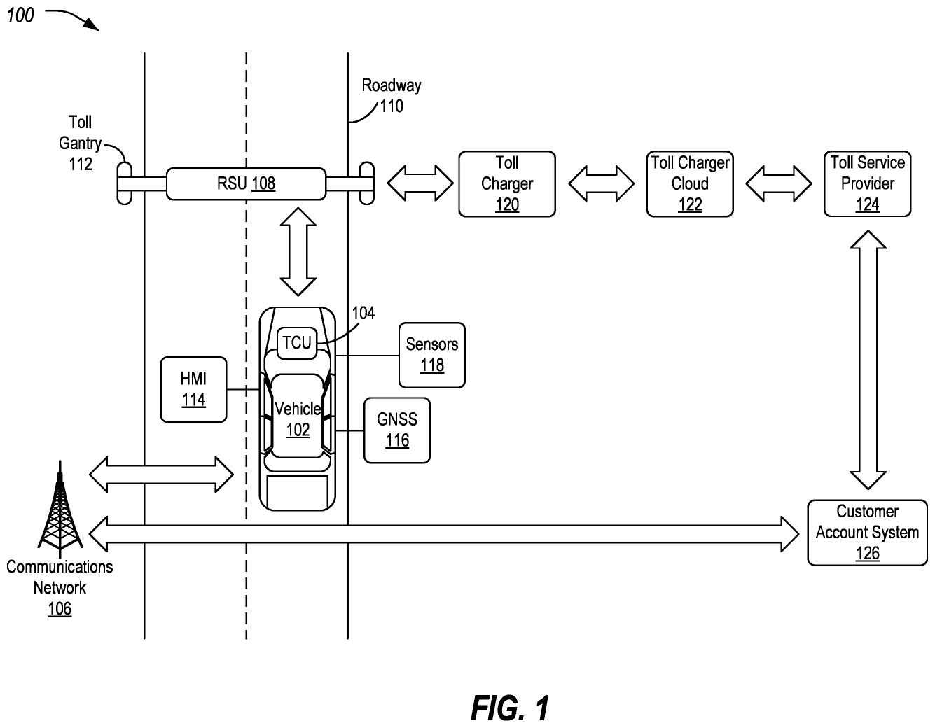

FIG. 1 illustrates an example tolling system 100 for V2X smart tolling leakage prevention. As shown, the tolling system 100 includes a wireless-enabled vehicle 102 configured to travel along a roadway 110. The vehicle 102 includes a telematics control unit (TCU) 104 and a human machine interface (HMI) 114. The tolling system 100 also includes a toll gantry 112 or other toll installation that includes a RSU 108. The RSU 108 may communicate with a toll charger server 120 over a secure channel (such as a wired connection), which in turn communicates with a toll pay center 122. The toll pay center 122 may also communicate with a toll agency hub 124 and a customer account system 126. Using the TCU 104, the vehicle 102 may communicate with the RSU 108 over a broadcast peer-to-peer protocol (such as PC5), and with a communications network 106 over a network protocol, which allows the vehicle 102 to communicate with the customer account system 126, for example. It should be noted that the tolling system 100 shown in FIG. 1 is merely an example, and systems having more, fewer, and different arrangements of elements may be used. For instance, one or more of the RSU 108, toll charger server 120, toll pay center 122, and toll agency hub 124 may be combined into a single device. Moreover, while only one vehicle 102 along one roadway 110 is shown, it is contemplated that tolling systems 100 would include many vehicles 102 and roadways 110 to traverse. As a further example, gantry-less tolling systems 100 without a physical toll gantry 112 are possible.

The vehicles 102 may include various other types of passenger vehicles, such as sedans, crossover utility vehicles (CUVs), vans, sport utility vehicles (SUVs), trucks, recreational vehicles (RVs), scooters, or other mobile machines for transporting people or goods. In many cases, the vehicle 102 may be powered by an internal combustion engine. In such cases, the fuel source may be gasoline or diesel fuel. As another possibility, the vehicle 102 may be a hybrid electric vehicle (HEV) powered by both an internal combustion engine and one or more electric motors, such as a series hybrid electric vehicle (SHEV), a parallel hybrid electric vehicle (PHEV), or a parallel/series hybrid electric vehicle (PSHEV). As yet a further possibility, the vehicle 102 may be an electric vehicle (EV) powered by electric motors without an internal combustion engine. As the type and configuration of vehicles 102 may vary, the capabilities of the vehicles 102 may correspondingly vary. As some other possibilities, vehicles 102 may have different capabilities with respect to passenger capacity, towing ability and capacity, and storage volume. For title, inventory, and other purposes, the vehicle 102 may be associated with a unique identifier, such as a vehicle identification number (VIN). The vehicle 102 may also be associated with a governmental registration, such as a license plate number.

The TCU 104 may be configured to provide telematics services to the vehicle 102. These services may include, as some non-limiting possibilities, navigation, turn-by-turn directions, vehicle health reports, local business search, accident reporting, and hands-free calling. The TCU 104 may accordingly be configured to communicate over various protocols, such as with a communications network 106 over a network protocol (such as Uu). The TCU 104 may, additionally, be configured to communicate over a broadcast peer-to-peer protocol (such as PC5), to facilitate cellular vehicle-to-everything (C-V2X) communications with devices such as the RSU 108. It should be noted that these protocols are merely examples, and different peer-to-peer and/or cellular technologies may be used.

The communications network 106 may provide communications services, such as packet-switched network services (e.g., Internet access, voice over Internet Protocol (VoIP) communication services), to devices connected to the communications network 106. An example of a communications network 106 is a cellular telephone network. For instance, the TCU 104 may access the cellular network via connection to one or more cellular towers. To facilitate the communications over the communications network 106, the TCU 104 may be associated with unique device identifiers (e.g., mobile device numbers (MDNs), Internet protocol (IP) addresses, etc.) to identify the communications of the TCU 104 on the communications network 106 as being associated with the vehicle 102.

The RSU 108 may be a device with processing capabilities and networking capabilities designed to be placed in proximity of a roadway 110 for use in communicating with vehicles 102. In an example, the RSU 108 may include hardware configured to communicate over the broadcast peer-to-peer protocol (such as PC5), to facilitate C-V2X communications with the vehicles 102. The RSU 108 may also have wired or wireless backhaul capability to allow for communication with other elements of the communications network 106, such as the toll charger server 120.

The toll gantry 112 may be framework installed across the roadway 110. The toll gantry 112 may serve as a location to mount hardware to give the hardware a clear view of the roadway 110. In an example, the RSU 108 may be mounted to the toll gantry 112. It should be noted that, in other examples, the RSU 108 may be located along the ground adjacent to the roadway 110 and the toll gantry 112 may be omitted.

The HMI 114 may include various output devices configured to provide information to users, as well as input devices configured to receive information from users. Output devices may include, as some examples, display screens, touch screens, projectors, lights, speakers, buzzers, and haptic feedback sensors. Input devices may include, as some examples, touch screens, keyboards, buttons, knobs, and microphones, as some possibilities.

A global navigation satellite system (GNSS) 116 controller may be utilized by the vehicle 102 to provide autonomous geo-spatial positioning for the vehicle 102. As some examples, the GNSS 116 controller may allow the vehicle 102 to determine its position using one or more satellite navigation systems, such as global positioning system (GPS), globalnaya navigatsionnaya sputnikovaya sistema (GLONASS), Galileo, Beidou and/or others.

The vehicles 102 may include one or more sensors 118. These sensors 118 may include, in some examples, cameras configured to capture visible light and/or infrared imagery surrounding the vehicle 102. In another example, the sensors 118 may include light detection and ranging (LIDAR) and or radio detection and ranging (RADAR) sensors to supplement the camera imaging.

The toll charger server 120 is a networked computing device configured to perform operations in support of the functionality of the RSU 108. In an example, the toll charger server 120 may be in communication with the RSU 108 and may be programmed to operate as a gateway between the RSU 108 and the toll pay center 122. The toll charger server 120 may be responsible for managing operations between the broadcast nature of the RSU 108 operations and the remainder of the tolling system 100. These operations may include, for example, verification of messages received from vehicles 102 by the RSU 108, certificate verification and identification, and communication with the toll pay center 122 to perform further operations over a secure line. In many examples, each RSU 108 may be supported by its own corresponding toll charger server 120. However, in other examples, a single toll charger server 120 may be configured to handle multiple RSUs 108, such as a set of RSUs 108 covering operation of the roadway 110.

The toll pay center 122 is a networked computing device configured to perform operations in support of the functionality of the tolling system 100. In an example, the toll pay center 122 may be programmed to perform operations in support of the payment aspects for use of the roadway 110 by the vehicle 102. In some examples, the tolling system 100 may include different toll pay centers 122, where each toll pay center 122 is configured to handle payments for those vehicles 102 having accounts with the toll pay center 122. As one possibility, different vehicle 102 manufacturers may each maintain their own toll pay center 122. As another possibility, vehicles 102 may subscribe to the use of various third-party toll pay centers 122.

The toll agency hub 124 is a networked computing device configured to perform operations in support of the functionality of the tolling system 100. The toll agency hub 124 may be configured to perform operations such as providing cost information to the various toll pay centers 122 with respect to the costs for usage of the roadway 110. For instance, the toll agency hub 124 may provide a toll schedule indicative of the costs of traversing the roadway 110, including costs for usage of different lanes (e.g., express, carpool, regular, etc.), usage for different classes of vehicles 102 (e.g., passenger cars, semi-trucks, etc.), usage for different times of day, and usage for high traffic vs low traffic situations. The toll agency hub 124 may also be configured to perform payment reconciliation operations, reporting functions, and may also provide information regarding vehicles 102 that are observed on the roadway 110 that may not have paid (e.g., as identified according to wireless transmissions of basic safety messages (BSMs), pictures from cameras, etc.).

The customer account system 126 is a networked computing device also configured to perform operations in support of the functionality of the tolling system 100. Using the customer account system 126 a user may set up a payment account, be charged by the toll charger server 120 for use of the roadway 110, and request and receive toll receipts with respect to usage of the roadway 110. Such payment transactions require the exchange of personal information with toll authorities over the air.

Tolling operations may be performed using the elements of the tolling system 100. For instance, the toll agency hub 124 may send a toll rate schedule to the toll charger server 120. This toll rate table may include information that may be used to allow a vehicle 102 to understand the charges that may be incurred to traverse the roadway 110. In a simple example, the toll rate schedule may indicate that the cost to traverse the roadway 110 is a fixed amount. However, in many examples, the cost to traverse the roadway 110 may vary according to various factors. For instance, travel in a first lane may incur a first charge, while travel in another lane may incur a second, different, charge. In another example, the cost may vary based on the number of occupants of the vehicle 102. In yet a further example, the cost may vary based on the type of vehicle 102 (e.g., a semitruck may incur a greater charge than a passenger car). In an even further example, costs may vary based on other factors, such as amount of traffic, time of day, day of week, and/or weather.

The toll charger server 120 may update rate details of toll advertisement message (TAM). In an example, the toll charger server 120 receives the toll rate schedule, identifies current rates, and updates rate information at the toll charger server 120. This rate information may be cached at the toll charger server 120 and sent to the RSU 108.

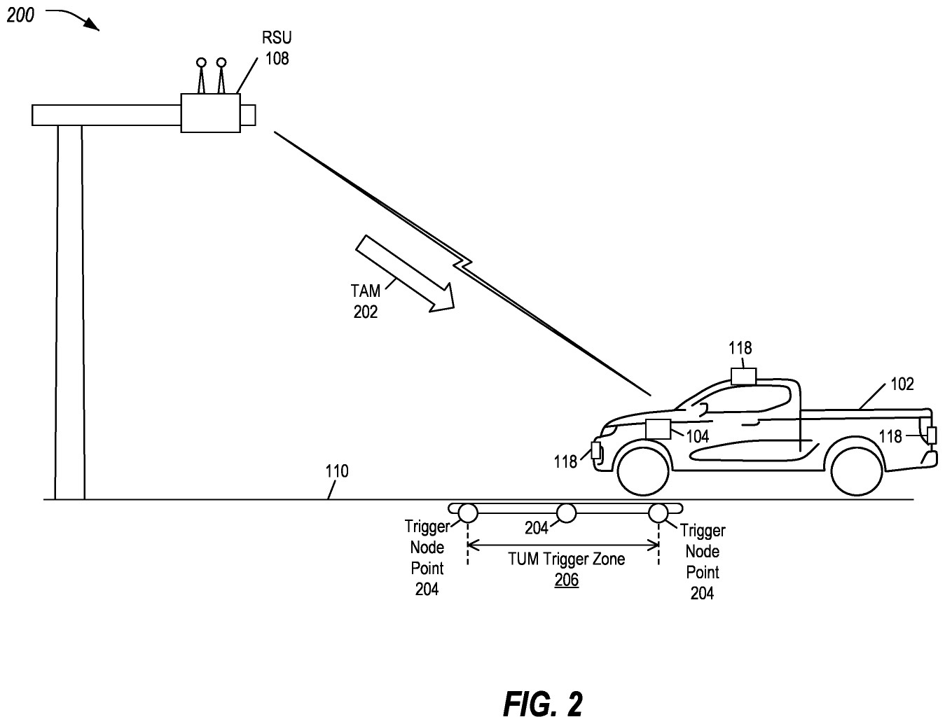

FIG. 2 illustrates an example 200 of the vehicle 102 approaching a toll gantry 112. As shown, the RSU 108 may broadcast the rate information as well as other information in a TAM 202 message. This broadcast may be a periodic broadcast. As one possibility, the TAM 202 may be rebroadcast on the order of every 100 milliseconds.

The TAM 202 may include various information useful for a vehicle 102 to understand usage of the roadway 110. This may include fields such as: a timestamp indicative of the time at which the TAM 202 was created or sent, toll types and toll amounts indicative of how the toll information is charged (e.g., based on the toll rate table), a layer type, a layer identifier, an identifier of the toll charger server 120, and an identifier of the toll pay center 122. The layer type may be a data element used to uniquely identify a type of information to be found in a layer of a geographic map fragment such as an intersection. The layer identifier may correspondingly be an identifier of map information. The identifier may be a globally-unique identifiers (GUID), to allow the toll pay centers 122 to be uniquely identified by the tolling system 100.

The TAM 202 may also include map information indicative of the layout of the roadway 110, such as an intersection geometry list and a road segment list. The road segment list include various properties of the roadway, including lane description, high occupancy status, and so on. This information may include, for instance, indications of the layout of the lanes of the roadway 110, which may be used to allow vehicles 102 to identify when a tolled area is approached, as well as in which lane the vehicle 102 is traveling.

For instance, the TAM 202 may define one or more trigger node points 204 that may collectively define the boundaries of a trigger zone 206. Further aspects of map data and other details of message elements described herein are further defined in the J2735 standard Dedicated Short Range Communications (DSRC) Message Set Dictionary™, published by Society of Automotive Engineers (SAE) International, the standard being incorporated herein by reference in its entirety. As shown, the TAM 202 defined a trigger zone 206 that the vehicle 102 has yet to approach.

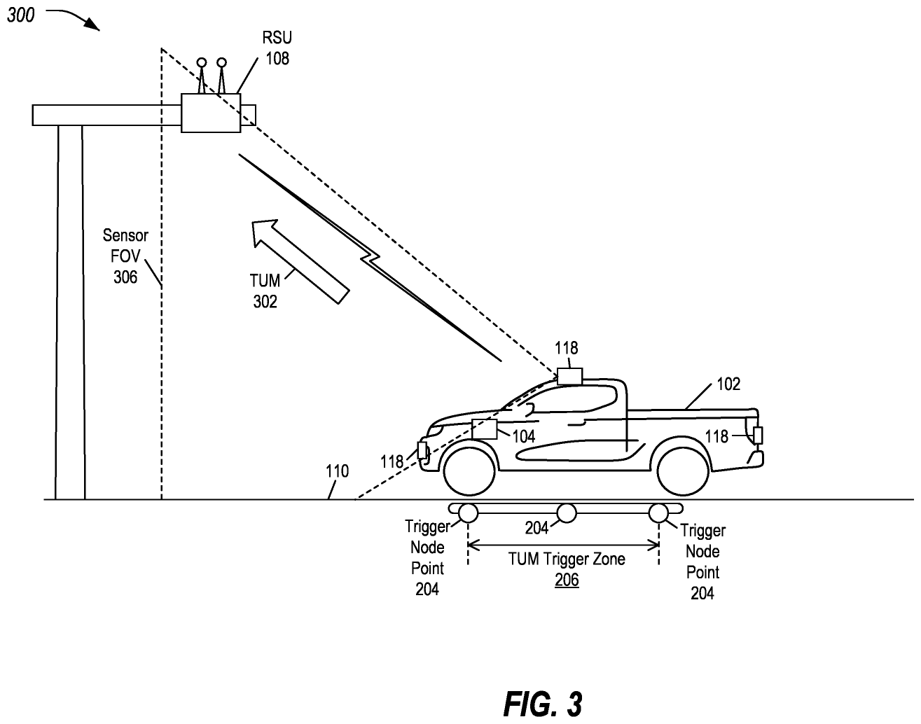

FIG. 3 illustrates an example 300 of the vehicle 102 approaching a toll usage location by having entered the trigger zone 206. As shown, in the example 300, the vehicle 102 has now reached the trigger zone 206.

Responsive to the vehicle 102 reaching the location, the TCU 104 may generate a TUM 302. The TUM 302 includes various information provided by vehicles 102 to RSUs 108 that indicates usage of the roadway 110 by the vehicle 102. This information may include fields such as a message count that indicates a unique number of the TUM 302 for the transaction. The message count may be used to help in identifying if any packet loss has occurred. The TUM 302 may also include a unique random identifier that may be used as a temporary account identifier or tag to track the transaction of messaging between the vehicle 102 and the broadcast message interface of the RSU 108, while preserving relative anonymity of the vehicle 102.

The TUM 302 may also include information about the vehicle 102 entry to the toll area. For instance, the TUM 302 may include a timestamp the time when the TUM 302 was created, latitude, longitude, and elevation of the vehicle 102, positional accuracy of the latitude, longitude, and elevation, speed of the vehicle 102, and heading of the vehicle 102. The TUM 302 may also include other information, such as type of the vehicle 102, an identifier of the toll charger server 120, and an identifier of the toll pay center 122. The identifiers may be GUIDs, to allow the toll charger servers 120 and toll pay centers 122 to be uniquely identified. The TUM 302 may also include an intersection identifier of the intersection through which the vehicle 102 entered the roadway 110, where the intersection identifier was received by the vehicle 102 in the TAM 202 (e.g., via the intersection geometry list and/or road segment list). The TUM 302 may also include a charge amount for the travel in the tolled area as determined by the vehicle 102 using the information in the TAM 202. Other information may also be included in the TUM 302, such as the distance traveled by the vehicle 102, a number of passengers in the vehicle 102, and a license plate number or other identifier of the vehicle 102.

The TCU 104 may update the HMI 114 to cause the HMI 114 to display a message indicating that the vehicle 102 entered the toll zone. The HMI 114 may further indicate that the vehicle 102 will be charged the amount indicated for the lane that the vehicle 102 is in.

The TCU 104 may send the TUM 302 to the RSU 108. In one example, the TUM 302 may be encoded with a key and/or signed using a certificate, and the RSU 108 may utilize a key or other information to decrypt and/or confirm the sender of the TUM 302 as being the TCU 104. The RSU 108 may forward the TUM 302 to the toll charger server 120. The toll charger server 120 may forwards the TUM 302 to the toll pay center 122 corresponding to the vehicle 102. The toll pay center 122 may verify the vehicle 102 account with the customer account system 126 and complete the transaction.

The example 300 diagram of the vehicle 102 may further show a field of view (FOV) 306 of the vehicle sensors 118. As shown, the vehicle 102 is traversing the roadway 110 and is heading towards the RSU 108. The sensors 118 may accordingly be able to image the location of the RSU 108 as the RSU 108 comes into the FOV 306. This sensor information is discussed in further detail below.

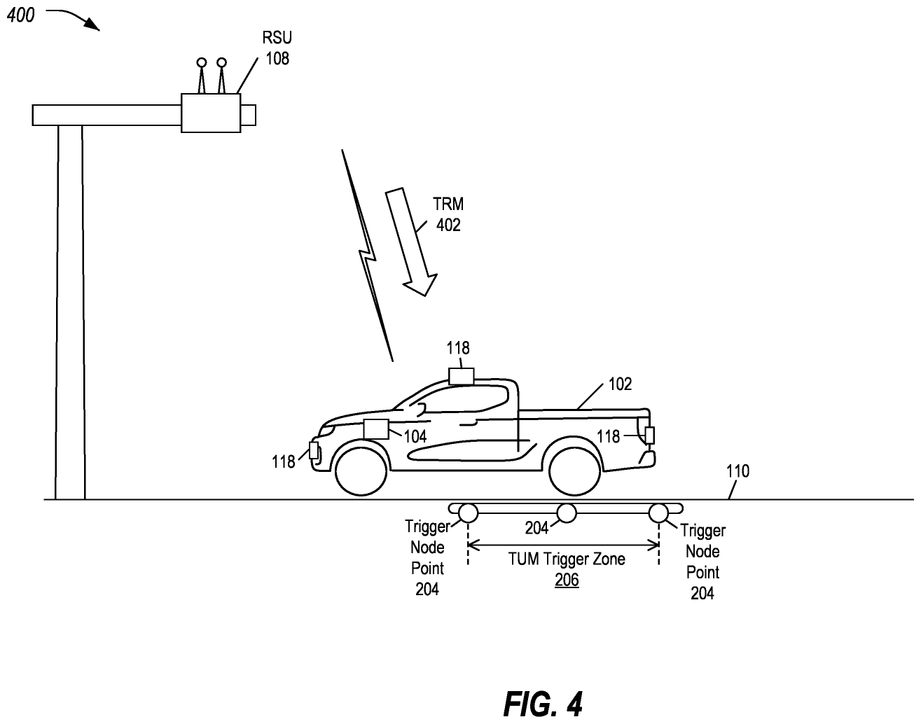

FIG. 4 illustrates an example 400 of the vehicle 102 receiving a TRM 402 for the completed tolling transaction. Responsive to receiving the TUM 302, the toll pay center 122 may accordingly generate the TRM 402 to be returned to the vehicle 102. The TRM 402 may include various information determined by the toll pay center 122 in support of completion of the toll transaction performed with the vehicle 102. This information may include a message count (to help in identifying if any packet loss has occurred), the account identifier from the TUM 302 (e.g., a unique random identifier from the TUM 302), the timestamp the time when the TUM 302 was created, an identifier of the toll charger server 120, and an identifier of the toll pay center 122 (e.g., a GUID). The TRM 402 may also include an intersection identifier of the intersection through which the vehicle 102 entered the roadway 110 (e.g., as indicated in the TUM 302 that was processed by the toll pay center 122), a lane identifier of which lane through which the vehicle 102 entered the roadway 110 (e.g., as indicated in the TUM 302 that was processed by the toll pay center 122), an intersection identifier of the intersection through which the vehicle 102 exited the roadway 110, and a lane identifier of which lane through which the vehicle 102 exited the roadway 110. The TRM 402 may also include the vehicle type and the amount charged for access to the roadway 110.

The toll pay center 122 may forward the TRM 402 to the toll charger server 120. In turn, the toll charger server 120 may forward the TRM 402 back to the RSU 108. The RSU 108 may broadcast the TRM 402, which may be received by the TCU 104 of the vehicle 102. The TCU 104 may update the HMI 114 to display a message indicating completion of the process and the final charged amount. It should be noted that while the TRM 402 is shown as being received close in time to the sending of the TUM 302, the TRM 402 may be received at a later time after the vehicle 102 has passed the toll gantry 112.

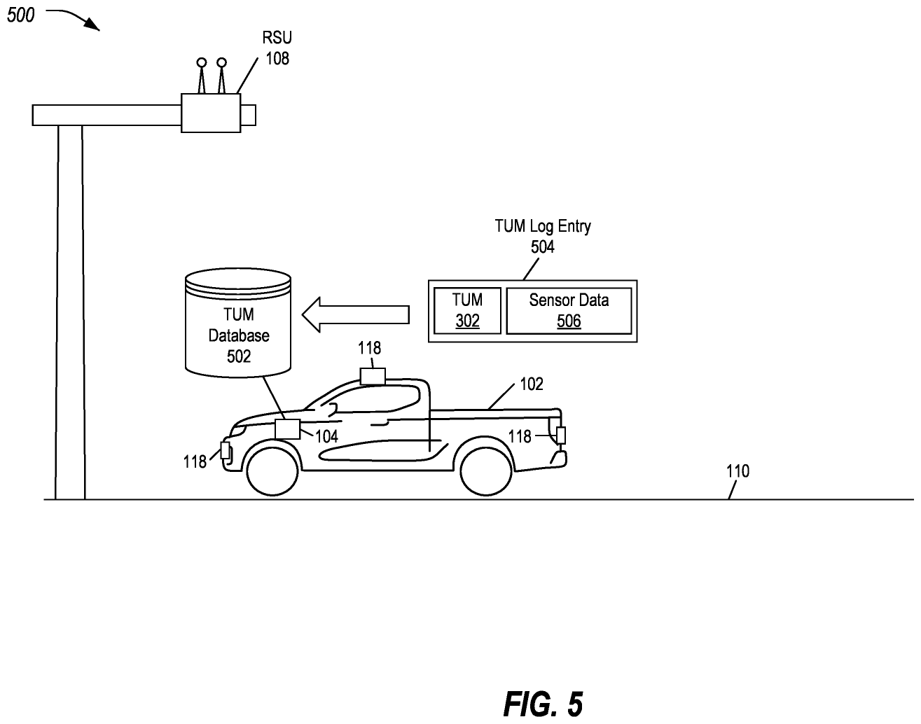

FIG. 5 illustrates an example 500 of the vehicle 102 storing the TUM 302 to a TUM database 502 of the vehicle 102. The TUM database 502 may be maintained by the TCU 104 or another on-board storage of the vehicle 102 that is accessible to the TCU 104. The TUM database 502 may include TUM log entries 504, where each TUM log entry 504 includes one of the TUMs 302 sent by the vehicle 102. Each TUM log entry 504 may also include sensor data 506 captured at the time of the sending of the TUM 302. For instance, this sensor data 506 may include an image of the toll gantry 112 and/or RSU 108 as captured by the vehicle 102 using the sensors 118. This sensor data 506 may be used as proof of presence of the vehicle 102 at the tolling location.

These TUM log entries 504 may be maintained as further proof of the reconciliation of the toll transaction, and as an approach to reducing of leakage during dispute resolution. For instance, if there is no TUM log entry 504 matching a claimed toll charger server 120, time and date on a TRM 402 or other tolling bill, then the vehicle 102 may have proof that the vehicle 102 did not use the toll service. Or, if there is a TUM log entry 504 maintained by the vehicle 102 that contradicts information in the TRM 402 or other bill, then the vehicle 102 may be able to use that information to automatically request a correction in the tolling amount.

In some examples, the vehicle 102 broadcasting the TUM 302 may create a blockchain record of the TUM 302. These records may be stored to the TUM database 502, creating a smart contract for use as proof for transaction reconciliation and dispute resolution processes. The vehicle 102 may also be used as proof of presence for the vehicle information originating from the vehicle 102 (e.g., the TUM 302) and broadcast from the vehicle 102, without assistance from existing toll gantry 112 equipment by the toll charger server 120 and vehicle proof of presence for assisting in the overall tolling leakage problem.

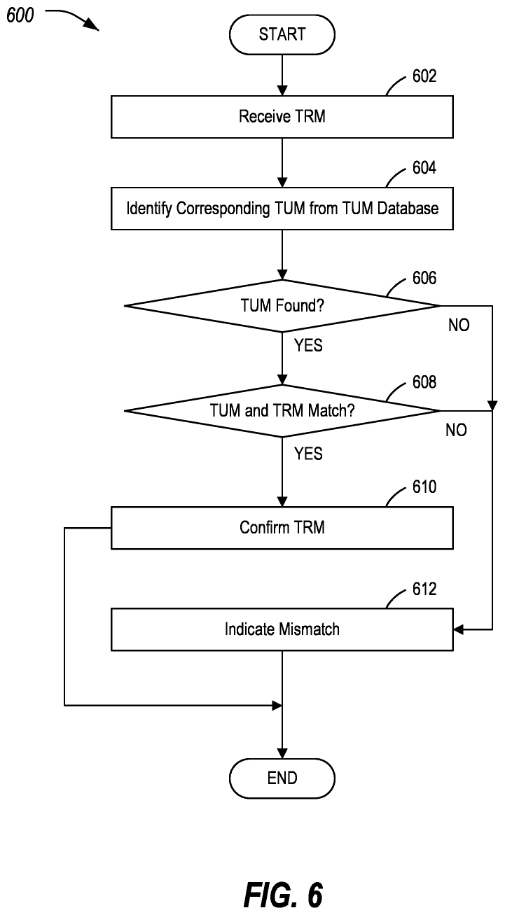

FIG. 6 illustrates an example process 600 for reconciling TRMs 402 by utilizing the TUM database 502. In an example, the process 600 may be performed by the vehicle 102 in the context of the tolling system 100.

At operation 602, the vehicle 102 receives a TRM 402. The TRM 402 may be generated by the toll pay center 122 responsive to the vehicle 102 sending a TUM 302 to the RSU 108 for the vehicle 102 having completed traversal of a roadway 110. In an example, the vehicle 102 receives the TRM 402 via a broadcast peer-to-peer protocol (such as PC5) from the RSU 108. In another example, the vehicle 102 receives the TRM 402 via the communications network 106 over a network protocol (such as Uu).

The TRM 402 may include information such as a message count (to help in identifying if any packet loss has occurred), the account identifier from the TUM 302, the timestamp the time when the TUM 302 was created, an identifier of the toll charger server 120, and an identifier of the toll pay center 122 (e.g., a GUID). The TRM 402 may also include an intersection identifier of the intersection through which the vehicle 102 entered the roadway 110 (e.g., as indicated in the TUM 302 that was processed by the toll pay center 122), a lane identifier of which lane through which the vehicle 102 entered the roadway 110 (e.g., as indicated in the TUM 302 that was processed by the toll pay center 122), an intersection identifier of the intersection through which the vehicle 102 exited the roadway 110, and a lane identifier of which lane through which the vehicle 102 exited the roadway 110. The TRM 402 may also include the vehicle type and the amount charged for access to the roadway 110.

At operation 604, the vehicle 102 identities a corresponding TUM log entry 504 for the TRM 402 in the TUM database 502. For instance, the vehicle 102 may access the TUM database 502 to determine whether the TUM database 502 includes a TUM log entry 504 including a TUM 302 matching the time, location, account identifier and/or other attributes from the TRM 402.

At operation 606, the vehicle 102 determines whether a corresponding TUM log entry 504 was found. For example, if a corresponding TUM log entry 504 was found at operation 604, control passes to operation 608. If not, control passes to operation 612 to indicate that the TRM 402 references a transaction not supported by the TUM database 502.

At operation 608, the vehicle 102 determines whether the TUM 302 included in the TUM log entry 504 and the TRM 402 are a match for the same tolling event. For instance, the vehicle 102 may verify that information in the TRM 402 matches to corresponding information in the TUM 302 of the retrieved TUM log entry 504. In an example, the vehicle 102 may confirm that latitude, longitude, and/or elevation of the vehicle 102 matches between the TUM 302 and the TRM 402. In another example, the vehicle 102 may confirm that speed and/or heading of the vehicle 102 matches between the matches between the TUM 302 and the TRM 402. In another example, the vehicle 102 may confirm that an identifier of the toll charger server 120, an identifier of the toll pay center 122, a license plate number of the vehicle 102, and/or a temporary account identifier of the tolling transaction of the TUM 302 matches between the TUM 302 and the TRM 402. If the TUM 302 and the TRM 402 are a match, control passes to operation 610. If not control passes to operation 612.

At operation 610, the vehicle 102 confirms the TRM 402. In an example, the vehicle 102 may indicate on the HMI 114 that the TRM 402 was received and successfully matches to the information in the TUM log entry 504. In another example, the vehicle 102 may send a confirmation to the sender of the TRM 402 indicating that the TRM 402 is approved by the vehicle 102. After operation 610, the process 600 ends.

At operation 612, the vehicle 102 indicates a mismatch of the TRM 402 to the TUM 302. In an example, the vehicle 102 may indicate on the HMI 114 that the TRM 402 was received but the TRM 402 does not correspond to a TUM log entry 504 in the TUM database 502. Or, the vehicle 102 may indicate in the HMI 114 what specific elements of the TRM 402 are a mismatch to the records of the vehicle 102.

As one non-limiting example, the vehicle 102 may list a first column of information (e.g., location, number of vehicle occupants, time of day, etc.) based on the TUM 302 of the TUM log entry 504 corresponding to the TRM 402. The vehicle 102 may also display a second column of information lined up with the first column showing the information in the TRM 402 and highlighting any differences. In another example, the vehicle 102 may list the items that differ between the TUM 302 and the TRM 402. It should be noted that these are only examples of a display of the differences, and other approaches may be used.

In some examples, the vehicle 102 may further utilize sensor data 506 from the TUM log entry 504 located at operation 606 to support the determination of the mismatch. For instance, the vehicle 102 may display images or other sensor data 506 that indicates the position and/or status of the vehicle 102 with respect to the transaction indicated by the TUM 302.

In another example, the vehicle 102 may additionally or alternately send a rejection of the TRM 402 indicating that the TRM 402 is disapproved by the vehicle 102. The rejection may also specify the indicated differences in the TRM 402 as compared to the TUM 302 and/or include the other sensor data 506 in support of the rejection of the TRM 402. After operation 612, the process 600 ends.

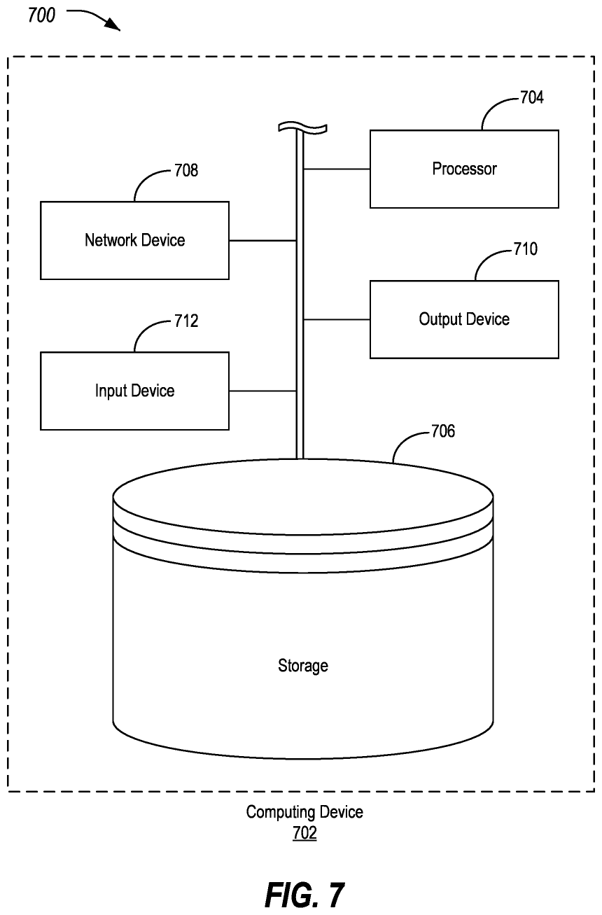

FIG. 7 illustrates an example computing device 702 for V2X smart tolling leakage prevention. Referring to FIG. 7, and with reference to FIGS. 1-6, the vehicle 102, TCU 104, communications network 106, RSU 108, GNSS 116, sensors 118, toll charger server 120, toll pay center 122, toll agency hub 124, and customer account system 126 may include examples of such computing devices 702. Computing devices 702 generally include computer-executable instructions where the instructions may be executable by one or more computing devices 702. Computer-executable instructions may be compiled or interpreted from computer programs created using a variety of programming languages and/or technologies, including, without limitation, and either alone or in combination, Java™, C, C++, C#, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data, such as the TAMs 202, TUMs 302, TRMs 402, and TUM log entries 504 of the TUM database 502, may be stored and transmitted using a variety of computer-readable media.

As shown, the computing device 702 may include a processor 704 that is operatively connected to a storage 706, a network device 708, an output device 710, and an input device 712. It should be noted that this is merely an example, and computing devices 702 with more, fewer, or different components may be used.

The processor 704 may include one or more integrated circuits that implement the functionality of a central processing unit (CPU) and/or graphics processing unit (GPU). In some examples, the processors 704 are a system on a chip (SoC) that integrates the functionality of the CPU and GPU. The SoC may optionally include other components such as, for example, the storage 706 and the network device 708 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 704 executes stored program instructions that are retrieved from the storage 706. The stored program instructions, accordingly, include software that controls the operation of the processors 704 to perform the operations described herein. The storage 706 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random access memory (RAM) that stores program instructions and data during operation of the tolling system 100.

The GPU may include hardware and software for display of at least two-dimensional (2D) and optionally three-dimensional (3D) graphics to the output device 710. The output device 710 may include a graphical or visual display device, such as an electronic display screen, projector, printer, or any other suitable device that reproduces a graphical display. As another example, the output device 710 may include an audio device, such as a loudspeaker or headphone. As yet a further example, the output device 710 may include a tactile device, such as a mechanically raiseable device that may, in an example, be configured to display braille or another physical output that may be touched to provide information to a user.

The input device 712 may include any of various devices that enable the computing device 702 to receive control input from users. Examples of suitable input devices 712 that receive human interface inputs may include keyboards, mice, trackballs, touchscreens, microphones, graphics tablets, and the like.

The network devices 708 may each include any of various devices that enable the described components to send and/or receive data from external devices over networks. Examples of suitable network devices 708 include an Ethernet interface, a Wi-Fi transceiver, a cellular transceiver, or a BLUETOOTH or Bluetooth Low Energy (BLE) transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A vehicle for smart tolling leakage prevention, comprising:
a toll usage message (TUM) database;
a transceiver; and
a controller programmed to
store a TUM to the TUM database, the TUM including information with respect to traversal of the vehicle along a roadway for which charges are incurred for travel,
send, via the transceiver, the TUM to a road-side unit (RSU) in communication with a tolling system,
receive, via the transceiver, a toll receipt message (TRM) from the tolling system, the TRM,
reconcile the TUM with the TRM, and
indicate a status of the reconcile.

2. The vehicle of claim 1, wherein the controller is further programmed to:
receive, via the transceiver, a toll advertisement message (TAM) broadcast from the RSU, the TAM indicating geographic locations of lanes of the roadway for which tolls are due and charge information for traversing the lanes of the roadway, and
include, in the TUM, an indication of usage of the lanes by the vehicle.

3. The vehicle of claim 2, wherein the TAM defines one or more trigger node points that define a boundary of a TUM trigger zone, and wherein the controller is further programmed to:
responsive to the vehicle entering the TUM trigger zone, capture sensor data using sensors of the vehicle and send the TUM; and
include both the sensor data and the TUM in a TUM log entry of the TUM database.

4. The vehicle of claim 3, wherein the sensor data includes image data of the surroundings of the vehicle at the time the vehicle sends the TUM.

5. The vehicle of claim 3, wherein the controller is further programmed to determine that the status is a mismatch of the TUM and the TRM responsive to one or more fields in the TUM and the TRM not being a match.

6. The vehicle of claim 5, wherein the one or more fields include data indicative of latitude, longitude, and/or elevation of the vehicle; speed and/or heading of the vehicle; an identifier of a toll charger server; an identifier of a toll pay center; a license plate number of the vehicle; and/or an account identifier specified in the TUM and the TRM.

7. The vehicle of claim 1, wherein to indicate the status of the reconcile includes to display the status in a human machine interface (HMI) of the vehicle.

8. The vehicle of claim 1, wherein to indicate the status of the reconcile includes to send the status to the tolling system.

9. The vehicle of claim 1, wherein the controller is further programmed to write the TUM to a blockchain record as a smart contract to automatically create an unalterable record of a toll transaction indicated by the TUM.

10. A method for smart tolling leakage prevention, comprising:
storing a TUM to a TUM database, the TUM including information with respect to traversal of a vehicle along a roadway for which charges are incurred for travel,
sending, via a transceiver of the vehicle, the TUM to a road-side unit (RSU) in communication with a tolling system,
receiving, via the transceiver, a toll receipt message (TRM) from the tolling system, the TRM,
reconciling the TUM with the TRM, and
indicating a status of the reconciling.

11. The method of claim 10, further comprising:
receiving, via the transceiver, a toll advertisement message (TAM) broadcast from the RSU, the TAM indicating geographic locations of lanes of the roadway for which tolls are due and charge information for traversing the lanes of the roadway, and
including, in the TUM, an indication of usage of the lanes by the vehicle.

12. The method of claim 11, wherein the TAM defines one or more trigger node points that define a boundary of a TUM trigger zone, and further comprising:
responsive to the vehicle entering the TUM trigger zone, capturing sensor data using sensors of the vehicle and send the TUM; and
including both the sensor data and the TUM in a TUM log entry of the TUM database.

13. The method of claim 12, wherein the sensor data includes image data of the surroundings of the vehicle at the time the vehicle sends the TUM.

14. The method of claim 12, wherein further comprising determining that the status is a mismatch of the TUM and the TRM responsive to one or more fields in the TUM and the TRM not being a match.

15. The method of claim 14, wherein the one or more fields include data indicative of latitude, longitude, and/or elevation of the vehicle; speed and/or heading of the vehicle; an identifier of a toll charger server; an identifier of a toll pay center; a license plate number of the vehicle; and/or an account identifier specified in the TUM and the TRM.

16. The method of claim 10, wherein to indicate the status of the reconciling includes displaying the status in a human machine interface (HMI) of the vehicle.

17. The method of claim 10, wherein to indicate the status of the reconciling includes sending the status to the tolling system.

18. The method of claim 10, further comprising writing the TUM to a blockchain record as a smart contract to automatically create an unalterable record of a toll transaction indicated by the TUM.

19. A non-transitory computer readable medium comprising instructions for smart tolling leakage prevention, that, when executed by a processor cause the processor to perform operations including to:
store a TUM to a TUM database, the TUM including information with respect to traversal of a vehicle along a roadway for which charges are incurred for travel,
send, via a transceiver of the vehicle, the TUM to a road-side unit (RSU) in communication with a tolling system,
receive, via the transceiver, a toll receipt message (TRM) from the tolling system, the TRM,
reconcile the TUM with the TRM, and
indicate a status of the reconcile.

20. The medium of claim 19, further comprising instructions that, when executed by the processor cause the processor to perform operations including to:
receive, via the transceiver, a toll advertisement message (TAM) broadcast from the RSU, the TAM indicating geographic locations of lanes of the roadway for which tolls are due and charge information for traversing the lanes of the roadway, and
include, in the TUM, an indication of usage of the lanes by the vehicle.

21. The medium of claim 20, wherein the TAM defines one or more trigger node points that define a boundary of a TUM trigger zone, and further comprising instructions that, when executed by the processor cause the processor to perform operations including to:
responsive to the vehicle entering the TUM trigger zone, capture sensor data using sensors of the vehicle and send the TUM; and
include both the sensor data and the TUM in a TUM log entry of the TUM database.

22. The medium of claim 21, wherein the sensor data includes image data of the surroundings of the vehicle at the time the vehicle sends the TUM.

23. The medium of claim 21, further comprising instructions that, when executed by the processor cause the processor to perform operations including to determine that the status is a mismatch of the TUM and the TRM responsive to one or more fields in the TUM and the TRM not being a match.

24. The medium of claim 23, wherein the one or more fields include data indicative of latitude, longitude, and/or elevation of the vehicle; speed and/or heading of the vehicle; an identifier of a toll charger server; an identifier of a toll pay center; a license plate number of the vehicle; and/or an account identifier specified in the TUM and the TRM.

25. The medium of claim 19, wherein to indicate the status of the reconcile includes to display the status in a human machine interface (HMI) of the vehicle.

26. The medium of claim 19, wherein to indicate the status of the reconcile includes to send the status to the tolling system.

27. The medium of claim 19, further comprising instructions that, when executed by the processor cause the processor to perform operations including to write the TUM to a blockchain record as a smart contract to automatically create an unalterable record of a toll transaction indicated by the TUM.
